(19) United States
(12) Patent Application Publication
(10) Pub. No.: US 2024/0345243 A1
(43) Pub. Date: Oct. 17, 2024

(54) SYSTEMS AND METHODS FOR SCANNING CONCEALED OBJECTS

(71) Applicant: VAYYAR IMAGING LTD., Yehud (IL)

(72) Inventors: Michael ORLOVSKY, Hod Ha-Sharon (IL); Raviv MELAMED, Nes Ziona (IL); Omer GAL, Tel Aviv (IL); Tanya CHERNYAKOVA, Tel Aviv (IL); Shay MOSHE, Petach-Tikva (IL); Assaf KARTOWSKY, Tel Aviv (IL)

(21) Appl. No.: 18/682,148

(22) PCT Filed: Aug. 8, 2022
(86) PCT No.: PCT/IB2022/057366

§ 371 Date: Feb. 8, 2024

Related U.S. Application Data
(60) Provisional application No. 63/230,751, filed on Aug. 8, 2021.
(60) Provisional application No. 63/317,992, filed on Mar. 9, 2022.

(51) Int. Cl. G01S 13/88; G01S 7/41; G01S 13/00; G01S 13/86; G01S 13/89; G01V 3/12

(52) U.S. Cl. CPC G01S 13/887; G01S 7/412; G01S 13/003; G01S 13/89; G01V 3/12; G01S 13/867

(57) ABSTRACT

Systems and methods for scanning concealed surface and detecting concealed objects using a radar. A radar-based sensor unit has an array of transmitters and receivers which transmit a beam of electromagnetic radiations towards a subject being scanned and receive the reflected electromagnetic signals. A processing unit receives raw complex image data from the radar unit and processes the data for detecting specific concealed objects. A display unit displays images representing the concealed object. A database stores the processed data from the processing unit along with the raw complex image and the processed image data. Stored data may be used to train the processing unit for accurately detecting the specific concealed objects. A communicator may transmit notifications through a communication network.

### CROSS-REFERENCE TO RELATED APPLICATIONS

This application claims the benefit of priority from U.S. Provisional Patent Application No. 63/230,751, filed Aug. 8, 2021, and U.S. Provisional Patent Application No. 63/317,992, filed Mar. 9, 2022, the contents of which are incorporated by reference in their entirety.

### FIELD OF THE INVENTION

The disclosure herein relates to systems and methods for scanning and detecting concealed objects. In particular, systems and methods are described for providing imageless and walk-through security scanners using a radar system and detecting concealed objects while providing privacy to the subject being scanned.

### BACKGROUND OF THE INVENTION

Concealed object detection can be a challenge, for example, to the law enforcement and security purposes. Handheld metal detectors are being used for the detection of hidden objects, e.g. objects such as weapons or metal objects concealed within the person's clothing or shoes, within packages or other opaque outer layers. However, metal detectors only detect metallic objects, furthermore they do not typically provide imaging data to indicate the shape or nature of the object detected. Such known screening methods can be ineffective in preventing some concealed objects from being detected, especially if they are made of plastic or liquid materials, for example.

Another known acoustic/ultrasonic detection systems uses acoustic/ultrasonic transducers to convert the electrical signal into an acoustic/ultrasonic signal and transmit the signal towards the object in the target area which is received and converted back to the electrical signal for processing.

Other known screening systems can use, for example, low level backscatter X-rays, chemical trace detection, etc. Some of these screening technologies, for example, those that employ ionizing radiation, may not be acceptable in some circumstances because they can be deemed to be harmful, especially for children, pregnant women, and elderly people. Consequently, x-rays devices are not suitable for walk-through scanners.

Full body scanners typically require a scanner to be rotated about the scanned subject so as to expose the whole of the surface of the subject to scanning radiation. Alternatively, the subject may rotate relative to the scanner. This can be time consuming and cumbersome. Practically this may limit the number of subjects that may be scanned particularly in security situations such as airports and the like where large numbers of subjects.

Walk-through scanners are a useful alternative to handheld scanners as they may allow individuals to be scanned in an unobtrusive manner and in a natural way as they proceed along a required path. Some radar based walk-through scanners are described in the applicants copending patent application number PCT/IB2020/059106, however in order to acquire clear images of moving objects a radar scanner requires a shorter scan time than is typically possible.

The problem of theft in production establishments like factories and warehouses is a major problem for the management. The use of cameras and video recorders provides help to a limited extent and does not effectively catch a person hiding a small object like a watch in his/her clothes.

The use of known concealed object detection systems have their limitation due to the size, shape, composition and configuration of the object. Further, these systems cannot be configured to detect specific objects and trigger alerts only when these objects are detected. For example, a metal detector triggers an alarm on detecting any metal object on the body of the person being scanned. Thus, there is a need for an improved system which detects specific concealed objects and reduces false alarm. The invention described herein addresses the above-described needs.

### SUMMARY OF THE EMBODIMENTS

In one aspect of the invention, a system for scanning and detecting specific concealed objects using a radar system is disclosed. The system includes a radar-based sensor unit, a processing unit, a database and a communicator.

In another aspect of the invention, the radar-based sensor unit may include an array of transmitters and receivers which are configured to transmit a beam of electromagnetic radiations towards the person being scanned and receive the electromagnetic waves reflected from the person, respectively. The information received by the receiver may include a raw complex image which may be a 3D matrix of voxels. The sensor unit may also include a pre-processing unit which is configured to prepare convoluted slices from the raw complex image. The exemplary convoluted slices that may be used by the pre-processing unit may include one or more of a maximum intensity slice, a range slice, a Laplacian slice and a median value slice. The processing unit receives the convoluted slices from the pre-processing unit for detecting concealed objects using convolutional neural network.

In a further aspect of the invention, the processed data from the processing unit along with the raw complex image collected by the receiver and the convoluted slices produced by the pre-processing unit are stored in the database. On the detection of the specific concealed objects, the communicator may transmit a notification to the concerned parties through a communication network.

As appropriate, an anomaly detector may be used to detect deviations from a standard body. Detected deviations may be indicative of possible detections of non-specific concealed objects.

As appropriate, the data stored in the database may be used to train the processing unit for accurately detecting the specific concealed objects thereby reducing false alarms.

In a further aspect of the invention, a method for scanning a target subject and detecting concealed objects is disclosed. The method comprising transmitting, by an array of transmitters, a beam of electromagnetic radiations towards the target subject and receiving, by an array of receivers, a beam of electromagnetic radiations reflected from the target subject, wherein the received electromagnetic radiations comprise a raw complex image. The method further comprises receiving, by a pre-processing unit, the raw complex image from the receivers and generating a plurality of convoluted slices and processing, by a processing unit, the convoluted slices for detecting the concealed object within the target subject.

As appropriate, the method further comprises storing, in a database, one or more of the raw complex images received by the receiver, the convoluted slices generated by the pre-processing unit and an identification of the detected concealed object.

As appropriate, the method further comprises training the processing unit for detecting the concealed objects using the information stored in the database.

As appropriate, the method further comprises transmitting, by a communicator, a notification of the detected concealed object to one or more concerned authorities through a communication network.

As appropriate, the method further comprises detecting, by an anomaly detector, deviation of the detected concealed object from a standard identification stored in the database.

In a still another aspect of the invention, a scanning device for imaging a concealed surface covered by an opaque outer layer is disclosed. The scanning device comprises a radar unit comprising a first array of electromagnetic transceivers along one a first side of a corridor which is configured to allow a subject to pass along an unobstructed path, wherein the electromagnetic transceiver is configured to transmit a beam of electromagnetic radiations towards the subject and receive the radiations reflected from the subject. The radar unit also comprises a second array of electromagnetic transceivers along a second side of the corridor configured to transmit a beam of electromagnetic radiations towards the subject and receive the radiations reflected from the subject, wherein the electromagnetic radiations received by the transceivers comprise a raw complex data comprising a set of magnitude and phase measurements corresponding to the reflected radiations. The radar unit further comprises a pre-processing unit configured to receive the raw complex data from the transceivers and applies a spatial reconstruction processing to the set of magnitude and phase measurements to reconstruct the amplitude at three-dimensional coordinates of interest within a target region.

In a further aspect of the invention, the scanning device comprises a processing unit. The processing unit comprises a data receiver configured to receive the amplitude at three-dimensional coordinates from the pre-processing unit and execute an image data generation function to generate image data based upon the received data. The processing unit also comprises a memory unit configured to store the image data and an image generator configured to convert the image data into a displayable image.

As appropriate, the scanning device further comprises a display unit configured to display an image of concealed objects within the concealed surface of the subject.

As appropriate, the scanning device is a walk-through scanner.

As appropriate, the scanning device is a multi-frame scanner comprising a scanning cycle, wherein each array of transceivers of each frame transmits electromagnetic radiations in turn during each scanning cycle.

As appropriate, each array of transceivers of each frame transmits electromagnetic radiations in parallel to reduce the scan time of the subject.

As appropriate, the first and the second array of transceivers are configured to transmit the electromagnetic radiations in parallel with distinct transmission frequencies, distinct modulation schemes or distinct duty cycles.

As appropriate, each of the transceivers comprises a frame board configured to communicate with the array of transceivers on its immediate neighbour frame. The frame board comprises a processor, a plurality of receiver connectors and a plurality of transmitter connectors, wherein each of the transmitter connector is configured to connect with the receiver connector of an adjacent frame board.

As appropriate, the frame board further comprises a bridge line configured to provide a direct transmission line between one of the receiver connectors and one of the transmitter connectors bypassing the processor.

In a yet another aspect of the invention, a method for imaging a concealed surface covered by an opaque outer layer is disclosed. The method comprising providing a radar unit comprising an array of transmitters connected to an oscillator and an array of receivers, transmitting, by the array of transmitters, a beam of electromagnetic radiations through the opaque outer layer towards the concealed surface of the subject and receiving, by the array of receivers, a beam of electromagnetic radiations reflected from the subject, wherein the electromagnetic radiations received by the receivers comprise a raw complex data comprising a set of magnitude and phase measurements corresponding to the reflected radiations. The method further comprises receiving, by a pre-processing unit, the raw complex data from the receivers and applying a spatial reconstruction processing to the set of magnitude and phase measurements to reconstruct the amplitude at three-dimensional coordinates of interest within a target region and receiving, by a processing unit, the amplitude at three-dimensional coordinates from the pre-processing unit and executing an image data generation function to generate image data based upon the received data. The method also comprises storing, by a memory unit, the image data and converting, by an image generator, the image data into a displayable image.

As appropriate, the method further comprises displaying an image of concealed objects within the concealed surface of the subject.

As appropriate, the method further comprises providing a corridor configured to allow a subject to pass along an unobstructed path, wherein the array of transmitters and the array of receivers are located along different walls of the corridor.

As appropriate, the method further comprises providing a multi-frame scanner comprising a scanning cycle, wherein each array of transmitters of each frame transmits electromagnetic radiations in turn during each scanning cycle.

As appropriate, the transmitting comprises transmitting electromagnetic radiations in parallel by each array of transmitters of each frame to reduce the scan time of the subject.

As appropriate, the transmitting comprises transmitting electromagnetic radiations in parallel by each array of transmitters of each frame with distinct transmission frequencies, distinct modulation schemes or distinct duty cycles.

As appropriate, the transmitting comprises transmitting electromagnetic radiations by each array of transmitters of a frame to the array of receivers on its immediate neighbour frame to reduce the scan time of the subject.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1 illustrates a schematic representation of a radar-based system 100 for scanning a subject and detecting specific concealed objects according to an aspect of the invention;

FIG. 2 illustrates a schematic representation of an exemplary scanning arrangement using a handheld scanner according to an aspect of the invention;

FIG. 3 illustrates a schematic representation of an exemplary scanning arrangement using a mounted full body scanner according to an aspect of the invention;

FIG. 4A is a schematic representation of a subject passing through an exemplary walk-through full body scanner according to an aspect of the invention;

FIG. 4B is a schematic representation of a top view of the exemplary walk-through full body scanner according to an aspect of the invention;

FIGS. 4C and 4D illustrate possible alternative full body scanners of the disclosure;

FIGS. 5A-5D are various alternative walkthrough scanners of the disclosure;

FIG. 6A indicates a set of four adjacent frames arranged in a two by two array;

FIG. 6B is a flowchart illustrating steps of a scanning cycle of multiple frames of a walkthrough scanner;

FIGS. 7A-7D schematically illustrate scanning cycle of an array including multiple frames;

FIG. 8 illustrates a flowchart showing method steps for scanning and detecting specific concealed objects using a radar system according to an aspect of the invention;

FIG. 9A illustrates a 2D graphical representation of pre-processing the raw complex image using Maximum Intensity convoluted slices;

FIG. 9B illustrates a 2D graphical representation of pre-processing the raw complex image using Range convoluted slices;

FIG. 9C illustrates a 2D graphical representation of pre-processing the raw complex image using Laplacian convoluted slices;

FIG. 9D illustrates a 2D graphical representation of pre-processing the raw complex image using Median value convoluted slices;

FIGS. 10A and 10B illustrate 2D graphical representations of pre-processing the raw complex image using Median value convoluted slices;

FIGS. 11A and 11B schematically illustrates a single transceiver frame and an array of transceiver frames for use in a possible trace based architecture;

FIG. 11C schematically illustrates a quartet of transceiver frames connected into a two by two array;

FIGS. 12A and 12B illustrates an alternative embodiment of a single transceiver frame and an array of the alternative transceiver frames for use in a possible trace based architecture; and

FIGS. 13A and 13B are possible antenna topologies for use in transceiver frames of the embodiments.

### DESCRIPTION OF THE SELECTED EMBODIMENTS

Aspects of the present disclosure relate to systems and methods for detecting concealed objects using a radar system. In particular, the disclosure relates to the use of a radar system which is trained to identify specific objects using machine learning. The transmission and reception of electromagnetic signals from the person being scanned produces a raw complex image. The raw complex image is processed to identify those specific concealed objects and trigger alarm.

Further aspects of the present disclosure relate to systems and methods for radar imaging of concealed surfaces. Radar based walk-through security scanners are provided which have scan times sufficiently fast to capture images of subjects passing therethrough in real time.

As required, the detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As appropriate, in various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials described herein for illustrative purposes only. The materials, methods, and examples not intended to be necessarily limiting. Accordingly, various embodiments may omit, substitute, or add various procedures or components as appropriate. For instance, the methods may be performed in an order different from described, and that various steps may be added, omitted or combined. In addition, aspects and components described with respect to certain embodiments may be combined in various other embodiments.

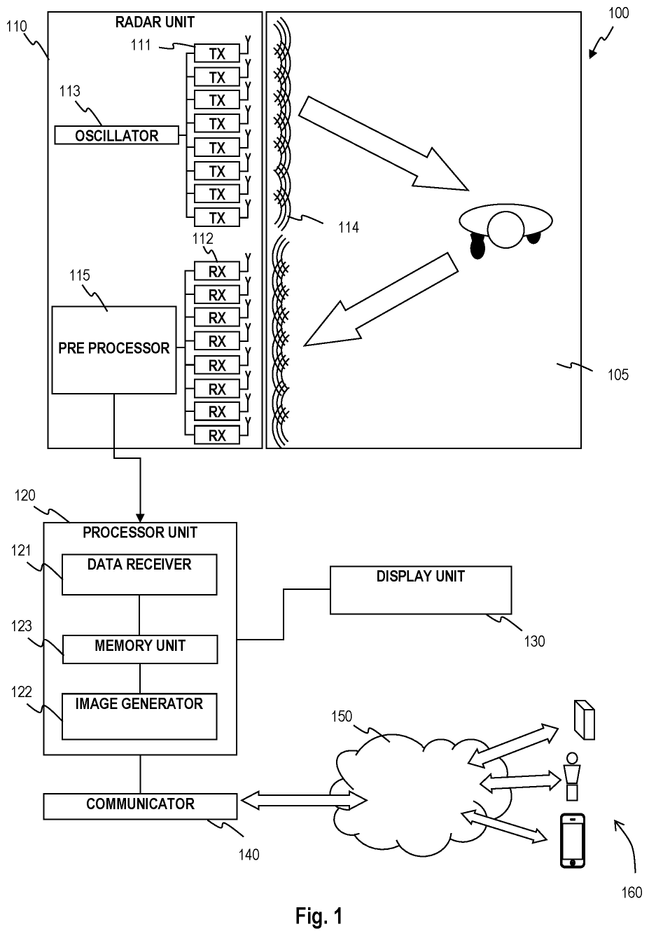

Reference is now made to FIG. 1, which is a schematic representation of a radar-based system 100 for scanning a subject and detecting specific concealed objects according to an aspect of the invention. The system 100 includes a radar unit 110, a processor 120, a display unit 130 and a communicator 140. The radar unit 110 includes at least one transmitter antenna 111 and at least one receiver antenna 112, an oscillator 113 and optionally a pre-processor 115. The transmitter 111 is connected to the oscillator 113 and configured to transmit electromagnetic radiation 114 into a target region 105. The receiver 112 is configured to receive electromagnetic waves reflected by objects within the target region 105 and is operable to generate raw data which may be processed by the preprocessor 115 where required.

The processor unit 120 is includes a data receiver 121 configured to receive data from the radar unit 110 and operable to execute an image data generation function to generate image data based upon the received data. A memory unit 123 is provided to store the image data thus generated and an image generator 122 may be operable to convert the image data into a displayable image. Accordingly, the display unit 130 is configured and operable to present an array of pixels displaying an image representing targets within the target region, such as concealed surfaces under the clothing of a passing subject for example.

The system 100 may be used within a production line of a factory establishment manufacturing objects, like watches, mobile phones, precious jewellery or gems, small vehicle parts, etc. The system 100 may alternatively be used within a warehouse storing objects which has the danger of theft and can easily be concealed within a person's body or clothing. The system 100 may further be used for security purpose at airports, shopping malls and other public places for detecting concealed weapons or bombs. The above-mentioned exemplary usage of the system 100 should not limit the scope of the invention.

The radar 110 typically includes at least one array of radio frequency transmitter antennas 111 and at least one array of radio frequency receiver antennas 112. The radio frequency transmitter antennas 111 are connected to an oscillator 113 (radio frequency signal source) and are configured and operable to transmit electromagnetic waves 114 towards the target region. The radio frequency receiver antennas 112 are configured to receive electromagnetic waves 114 reflected back from objects within the target region.

Accordingly, the transmitter 111 may be configured to produce a beam of electromagnetic radiation 114, such as microwave radiation or the like, directed towards a monitored region such as an enclosed room or the like. The receiver may include at least one receiving antenna or array of receiver antennas 112 configured and operable to receive electromagnetic waves reflected by objects within the monitored region.

In order for concealed objects to be rendered visible by a radar, it is a particular feature of the current disclosure that the frequency of transmitted radiation is selected such that concealing layers are transparent to the transmitted radiation and the reflected radiation which pass therethrough.

The raw data generated by the receivers 112 is typically a set of magnitude and phase measurements corresponding to the waves scattered back from the objects in front of the array. Spatial reconstruction processing is applied to the measurements to reconstruct the amplitude (scattering strength) at the three-dimensional coordinates of interest within the target region. Thus, each three-dimensional section of the volume within the target region may represented by a voxel defined by four values corresponding to an x-coordinate, a y-coordinate, a z-coordinate, and an amplitude value.

The communication module 140 is configured and operable to communicate information to third parties 160. Optionally the communication module 140 may be in communication with a computer network such as the internet 150 via which it may communicate alerts to third parties for example via telephones, computers, wearable devices or the like 160.

The system 100 is trained to detect specific objects within the environment in which it is being used and trigger the alert only on the detection of these objects. For example, the system 100 used in a production line manufacturing watches is trained to detect and raise alert only for the concealed watches and not for other objects. Similarly, the system 100 being used in a jewellery manufacturing unit is configured to detect only jewellery items.

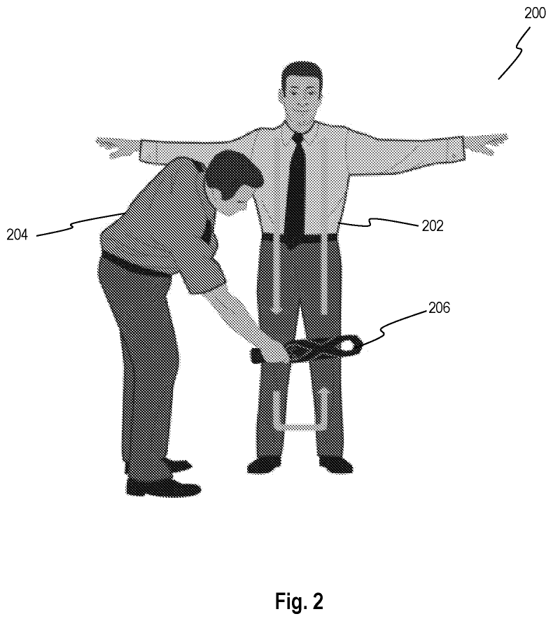

The radar-based sensor unit 104 may be a portable hand device 206 as shown in FIG. 2 which illustrates a schematic representation of an exemplary scanning arrangement 200 using the handheld scanner 206 according to an aspect of the invention. The scanner 206 is used to scan a person 202 by a security official 204 by moving the scanner 206 over the entire body of the person 202. The radar-based scanner 206 transmits electromagnetic signals towards the whole body of the person 202.

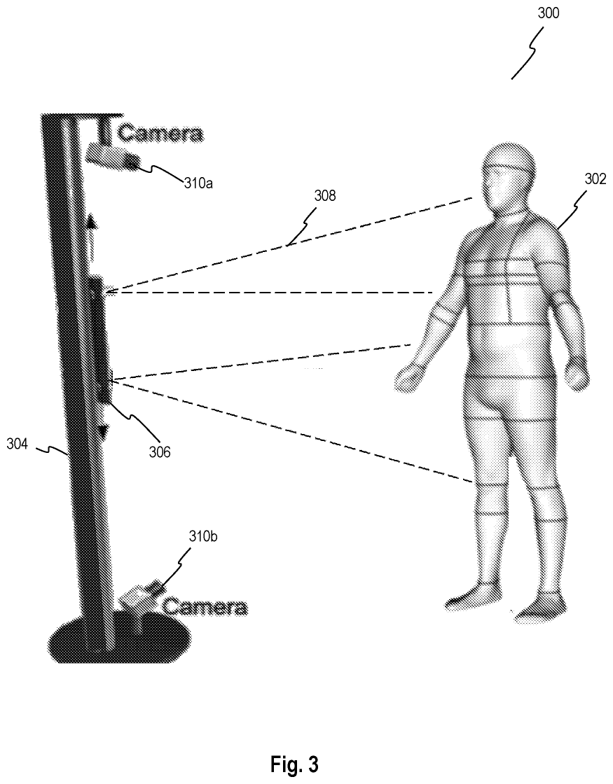

In an alternative embodiment, the radar-based sensor unit 104 may be a mounted full body scanner 306 mounted on a pole 304 as illustrated in FIG. 3. The scanner 306 transmits electromagnetic signals 308 towards a person 302 being scanned. The scanning arrangement 300 may also include cameras 310a and 310b mounted on the pole 304 for capturing an image of the person 302.

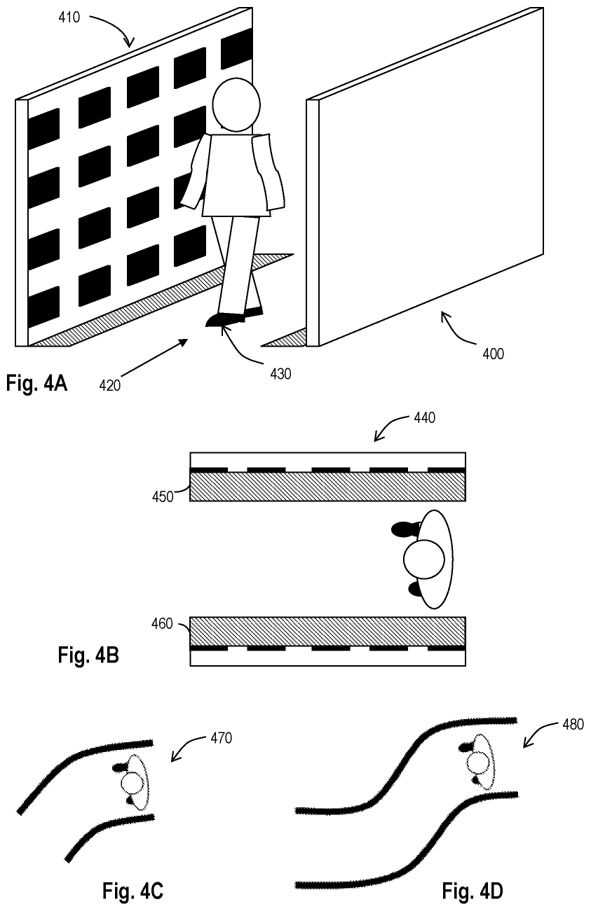

In a yet another alternative embodiment, the radar-based sensor unit 104 may be walk-through full body scanner as illustrated in FIGS. 4A and 4B which schematically represent respectively an isometric view 400 and a top view 440 of a subject 430 passing through an example of a walk-through full body scanner.

The full body scanner of the example includes a scanning arrangement 410 and a corridor 420 through which the subject 430 may pass.

The scanning arrangement includes a first array of transceivers 450 and a second array 460 facing the first array. The corridor 420 through the scanning arrangement provides an unobstructed path between the facing arrays of the scanning arrangement.

As the subject 430 passes along the unobstructed path, radiation emitted by transmitters 450 and 460 of the scanning arrangement is reflected from the subject 430 to be detected by receivers. Variously, the scanning radiation may be emitted by a transmitter of the first array 450 and reflected by the subject back towards receivers of the first array. Similarly, the scanning radiation may be emitted by a transmitter of the second array 460 and reflected by the subject back towards receivers of the second array.

Alternatively, the scanning radiation may be emitted by a transmitter of one array and reflected by the subject towards receivers of the other array. Thus, the radiations received by the first array 450 may have been emitted by the first array or the second array. Similarly, the radiations received by the second array 460 may have been emitted by first array or the second array.

In order to provide a 360 degree all round scanning, the dimensions, such as length and width of the corridor 420 are chosen such that a subject 430 passing along the length of the corridor 420 will at some position along the path reflect scanning radiation towards a receiver from every part of its surface. Accordingly, as the subject 430 passes along the unobstructed path, for each surface-section of the subject 430, there is a position along the path at which scanning radiation transmitted from at least one transmitter of the scanning arrangement is reflected by that surface-section and received by at least one receiver of the scanning arrangement. Furthermore, where appropriate, it may be possible to achieve full 360 degree coverage in as small a number of frames as possible.

Although only two walls are indicated in the FIGS. 4A and 4B for illustrative purposes, where required, additional scanning arrays may be provided above and below the corridor to increase coverage range when necessary.

Referring now to FIGS. 4C and 4D, which illustrate alternative full body scanners 470 and 480, it is noted that other configurations of the walk-through scanner may have curved paths. A subject passing along the corridor of such scanning arrays naturally turns relative to the scanning arrangements within the walls and thus the scanning arrays may more readily image the subject from the sides, the front and the rear thereby providing 360 degree imaging.

In the scanning arrangements 200, 300 and 400 of FIGS. 2, 3 and 4, respectively, the scanners 206, 306 and 410 may comprise the radar-based sensor unit 110. The other components of the system 100 like the processor 120, the communicator 140 and the display unit 130 may be located at a remote central terminal or at remotely distributed terminals. In such a case, the scanners 206, 306 and 410 may transmit the preprocessed data to the remotely located processing unit 120 for detecting the concealed objects. In an alternative embodiment, the pre-processing unit 115 may also be a separate unit and located remotely from the scanners 206, 306 and 410. In a further alternative embodiment, all the components including the radar-based sensor unit 110, the processor 120, the communicator 140 and the display unit 130 may be located within the scanners 206, 306 and 410.

It has been found that in order to clearly image a moving subject using a radar scanning apparatus, the subject must not move significantly during each scanning cycle. Accordingly, where the radar scanner uses scanning radiation with millimeter scale wavelength, it is important that the subject moves less than about a millimeter during each scan cycle. Methods are described herein for providing scanning cycles with scan times or less than a few milliseconds suitable for imaging walking subjects.

Referring back to FIG. 1, the radar-based system 100 may be used, say, in a production line manufacturing wrist watches. Accordingly, the system 100 is trained to detect concealed watches using Machine Learning (ML) algorithms. The system 100 may employ any of the known ML algorithm as per the requirement. The algorithm can be a Supervised Learning algorithm which consists of a target/outcome variable (or dependent variable) which is to be predicted from a given set of predictors (independent variables). Exemplary Supervised Learning algorithms include Regression, Decision Tree, Random Forest, KNN, Logistic Regression etc. Alternatively, algorithm can be a Reinforcement Learning algorithm using which the machine is trained to make specific decisions. Exemplary Reinforcement Learning algorithm includes Markov Decision Process.

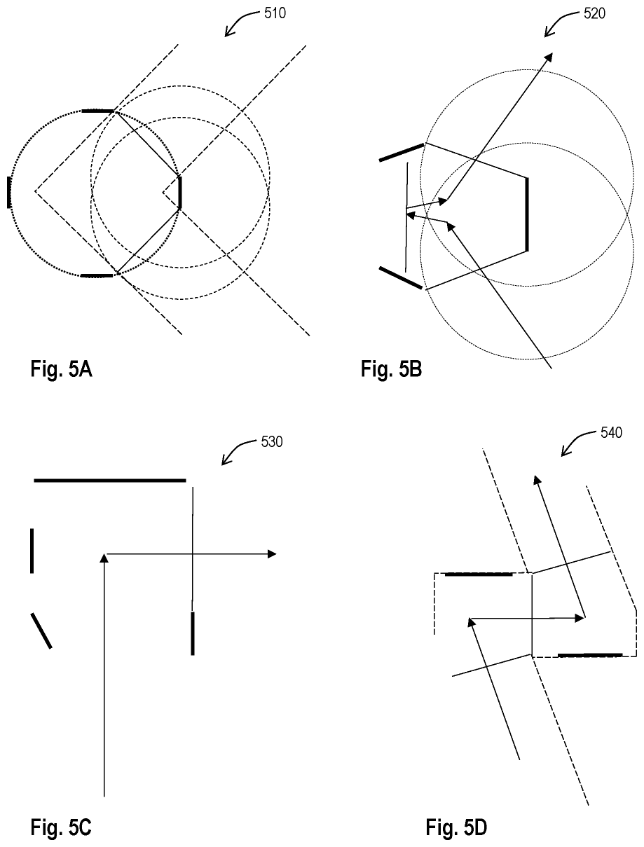

Referring now to FIGS. 5A-5D, various configurations for walkthrough scanners of the disclosure are indicated which may enable effective all round scanning of subjects passing along a path therethrough. It is noted that typical constraints for such configurations maybe that the corridor entering the scanning region may have an opening of approximately 75 centimeters or so and that subjects passing along the corridor should not have to rotate through angles greater than 90 degrees.

Accordingly, FIG. 5A indicates a first configuration 510 in which a corridor is provided leading the subject through a target region in which scanners are provided which has scanners around four sides of the subject as the subject turns: in front of the subject, behind the subject, to the right of the subject and to the left of the subject.

Other configurations will occur to those skilled in the art. For example, FIG. 5B indicates an alternative arrangement 520 in which only three scanning arrays are provided but the subject is required to make an about turn, FIG. 5C indicates another arrangement 530 requiring a 90 degree turn from the subject but having a different scanning configuration, FIG. 5D indicates, still a further arrangement 540 in which the subject is required to make two turns through a kind of chicane corridor which serves both to provide walls upon which to mount the scanners and also to slow the subject passing through the scanner.

It is a particular feature of the current disclosure that the radar scanning apparatus has a short enough scan time that a clear image may be provided of a subject passing through the target region. Accordingly, a method is taught for reducing the scan time in a multiframe scanner.

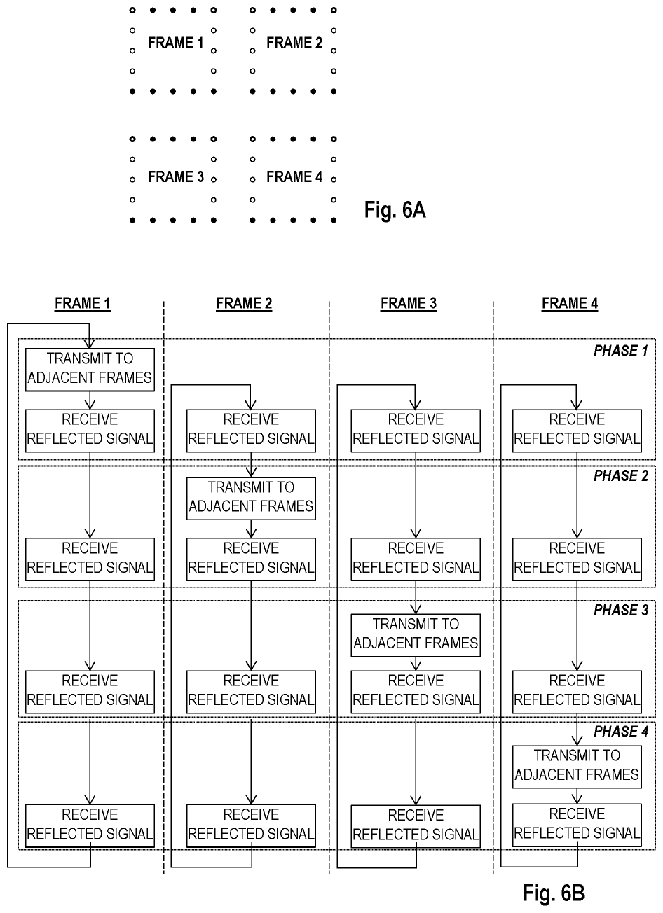

Referring now to FIG. 6A, which illustrates a quartet of four adjacent frames arranged in a two by two array and FIG. 6B which indicates a method of operation for each of the set of four frames.

Typically, in multiframe scanners, a scanning cycle involves each frame transmitting in turn to all other frames in the scanning array. Thus the total scan time is equal to the number of frames in the scanner array times the time required for each frame to transmit at each required transmission frequency. In order to reduce the scan time, frames of the scanning arrangement of the current disclosure may be configured and operable to transmit in parallel. For example, parallel transmission may be enabled by each transmitter transmitting in parallel at a distinct frequency, with a distinctive modulation, with a distinctive duty cycle or the like.

Accordingly, as indicated in FIG. 6A each frame in every quartet of the scanning arrangement is labeled such that the top left frame is labeled FRAME 1, the top right frame is labeled FRAME 2, the bottom left frame is labeled FRAME 3, and the bottom right frame is labeled FRAME 4. In this way, all frames labeled FRAME 1 are configured to transmit in parallel, all frames labeled FRAME 2 are configured to transmit in parallel, all frames labeled FRAME 3 are configured to transmit in parallel, and all frames labeled FRAME 4 are configured to transmit in parallel.

With reference to the flowchart of FIG. 6B the steps of a four phase scanning cycle are presented for reducing the scan time for the multiple frames of a walkthrough scanner. During the first phase only FRAME 1 of each quartet transmits and all the frames receive the reflected signal. During the second phase only FRAME 2 of each quartet transmits and all the frames receive the reflected signal. During the third phase only FRAME 3 of each quartet transmits and all the frames receive the reflected signal. During the fourth phase only FRAME 4 of each quartet transmits and all the frames receive the reflected signal. The cycle then returns to the first phase and this is repeated.

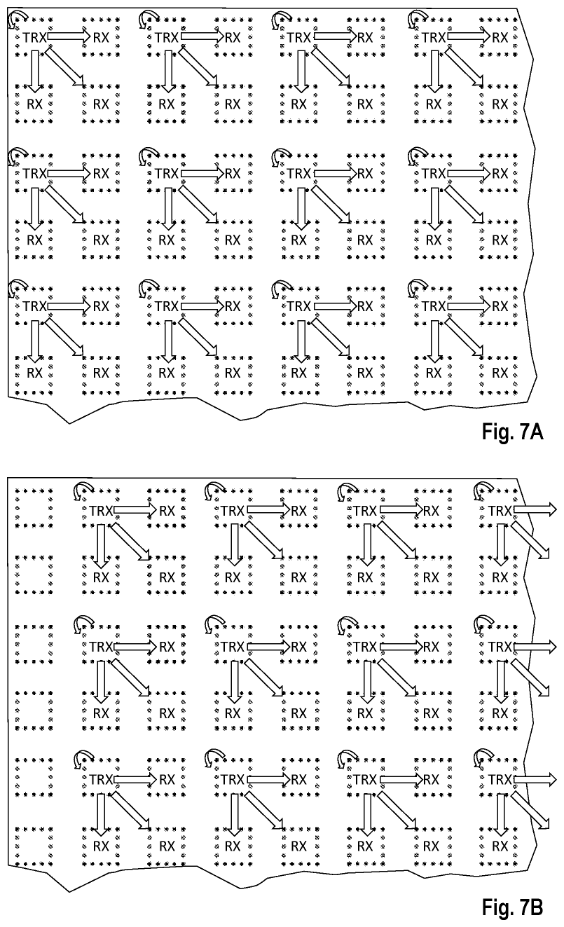

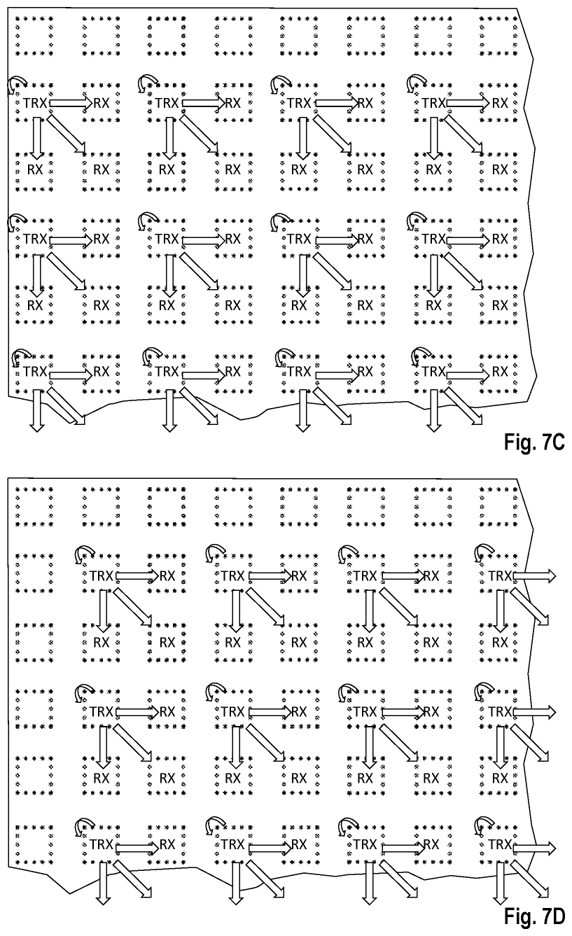

Referring now to FIGS. 7A-7D, the scanning cycle across the multiple frame array has a greatly reduced scan time because each frame only transmits to its immediate neighbors. FIG. 7A illustrates the transmission status during Phase 1 of the cycle during which all the FRAME 1 transceivers transmit to themselves and their immediate neighbors. Similarly FIG. 7B illustrates the transmission status during Phase 2 of the cycle during which all the FRAME 2 transceivers transmit to themselves and their immediate neighbors. Likewise FIG. 7C illustrates the transmission status during Phase 3 of the cycle during which all the FRAME 3 transceivers transmit to themselves and their immediate neighbors. Finally, FIG. 7D illustrates the transmission status during Phase 4 of the cycle during which all the FRAME 4 transceivers transmit to themselves and its immediate neighbors.

Referring back to FIG. 1, in an aspect of the present disclosure, the system 100 is used for imageless scanning and detecting concealed objects using the radar system 110. The receiver 112 may include an array of receiver antennas configured and operable to receive electromagnetic waves reflected by objects within the target region 105. In a preferred embodiment, the information received by the receiver 112 may include a raw complex image which may be a 3D matrix of voxels (say 181×181×24).

The raw complex image received by the receiver 112 are sent to the pre-processing unit 115 of the radar-based sensor unit 110. The raw image may be processed to detect concealed objects using a variety of methods. By way of example, in some embodiments, the pre-processing unit 115 is configured to prepare convoluted slices (say 181×181) from the raw complex image. The various exemplary convoluted slices that may be used by the pre-processing unit 115 include:
1. a maximum intensity slice which is a matrix of the energy levels of the voxels with the highest intensity for each pair of orthogonal coordinates.
2. a Range slice which is a matrix of the argument values of the voxels with the highest energy values for each pair of orthogonal coordinates.
3. a Laplacian slice which is a matrix of phase values of the z-plane containing the voxel having the highest intensity.
4. a median value slice which is a matrix of average energy values for each voxel.

The following data preprocessing algorithm may be employed by the pre-processing unit 115:
Raw Complex Image:
   181×181×24
Preprocessed Slices:
   Intensity=max (abs (I)
   Range=argmax (abs (I))
   Laplacian on the phase of the z-slice containing the max value
   Median Intensity
   Median Depth
Preprocessed Image
   181×181×5

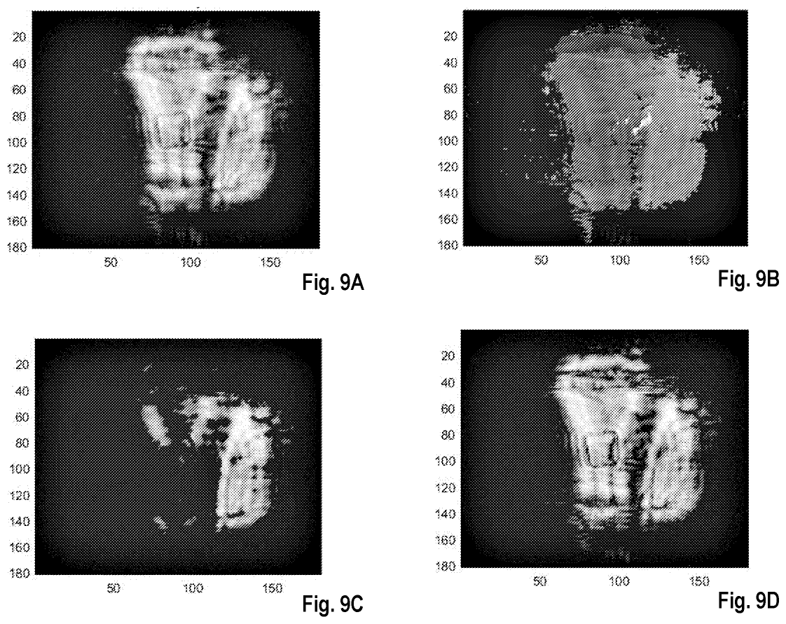

FIGS. 9A-9D illustrate two-dimensional (2D) graphical representations of pre-processing the raw complex image using Maximum Intensity convoluted slices (FIG. 9A), Range convoluted slices (FIG. 9B), Laplacian convoluted slices (FIG. 9C), and Median value convoluted slices (FIG. 9D).

By way of illustration only, in some embodiments, the raw complex image may be preprocessed using median value convoluted slices as per the following algorithm:
Given 3dImage (181×181×24)−I
Calculate Raw_Depth=argmax (I) in z dimension.
Median_Depth=median (Raw_depth) on X and Y coordinates, filter kernel size 15.
Calcualte Median_Intensity=I(z=Median_Depth)
Processing is performed on Median_Intensity

It will be appreciated that other preprocessing may be preferred as suit requirements. For example, in some examples the image may be cropped to remove borders or spacers.

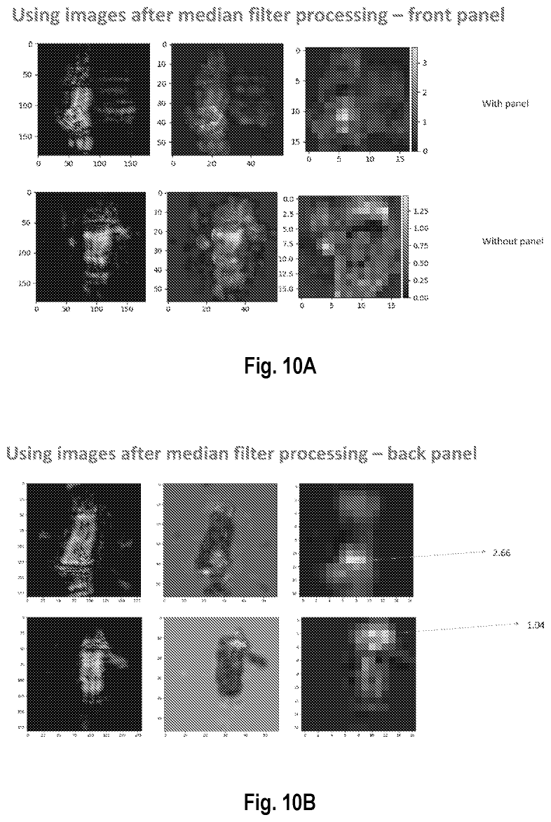

FIGS. 10A and 10B illustrate 2D graphical representations of pre-processing the raw complex image using median value filtering process.

The convoluted slices produced by the pre-processing unit 115 are sent to the processing unit 120 which is configured to analyze the slices and detect the concealed objects using a Convolutional neural network. The Convolutional neural network is a machine learning deep neural network which is configured to detect specific objects as per the environment in which the system 100 is being used. In an exemplary embodiment, the processing unit 120 is trained to detect wrist watches concealed in clothes or body of a person in the target region 105. The processing unit 120 is further configured to detect the position of the concealed objects. For example, the processing unit 120 is configured to detect the wrist-watch tied on the hand of the person and hidden inside the sleeves of the shirt. Similarly, in a jewelry manufacturing unit, the processing unit 120 is configured to detect a gemstone hidden in the shoes of a person.

The processed data from the processing unit 120 is stored in the database 123. The database 123 may also store the raw complex image collected by the receiver 112 and the convoluted slices produced by the pre-processing unit 115. All or some of these data may be used to train the processing unit 120 for detecting the concealed objects.

As and when required, the detection of concealed objects may trigger an alarm or notification to alert the concerned authorities 160 via the communicator 140. The concerned authorities may include the security personal who is scanning the person. The notification may also be sent to a factory supervisor in case a concealed object is detected with the factory worker. The notification may also be sent to a nearby police station of the possible theft. The notification may further be sent on the mobile device of the warehouse owner. The notification may be provided in audio/visual form.

The notifications may be sent from the database 123 through the communicator 140 which transmits the information through a communication network 150. The communication network 150 may include Internet, a Bluetooth network, a Wired LAN, a Wireless LAN, a WiFi Network, a Zigbee Network, a Z-Wave Network or an Ethernet Network.

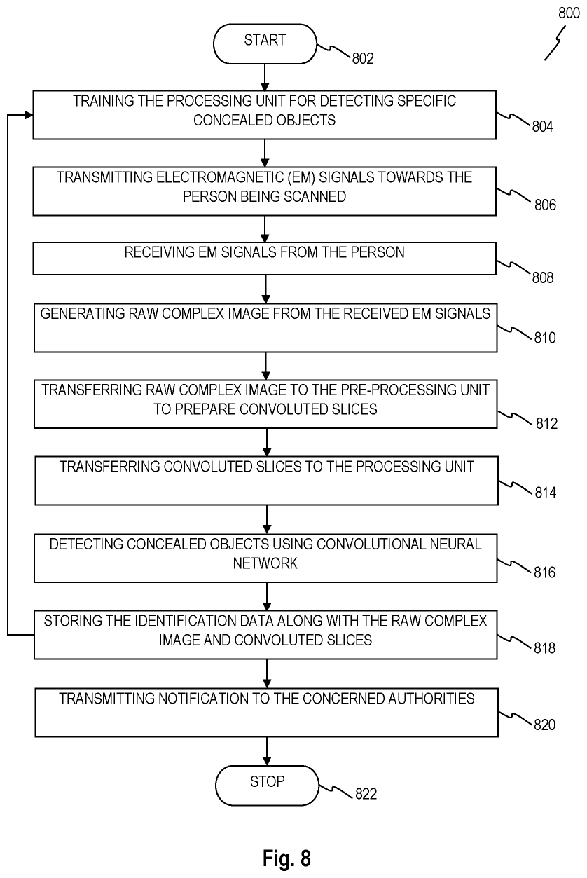

Referring to FIG. 8 which illustrates a flowchart 800 showing method steps for scanning and detecting specific concealed objects using the radar system 100 according to an aspect of the invention. The process starts at step 802 and the processing unit 120 is trained for detecting specific concealed objects at step 804. The processing unit 120 is trained to detect specific objects as per the environment in which the system 100 is being used. Accordingly, the processing unit 120 may be trained to detect concealed objects using Machine Learning (ML) algorithms. The processing unit 120 may employ any of the known ML algorithm as per the requirement.

At step 806, the EM signals from the transmitting antennas 111 of the radar unit 110 are transmitted to the person being scanned in the target region 105. The signals reflected from the person are received by the receiver antennas 112 at step 808 and are used to generate a raw complex image which may be a 3D matrix of voxels (say 181×181×24) at step 810. At step 812, the raw complex image is sent to the pre-processing unit 115 of the radar-based sensor unit 110. The pre-processing unit 115 is configured to prepare convoluted slices (say 181×181) from the raw complex image. The exemplary convoluted slices that may be used by the pre-processing unit 115 may include one or more of a maximum intensity slice, a range slice, a Laplacian slice and a median value slice.

At step 814, the convoluted slices are sent to the processing unit 120 for detecting concealed objects using convolutional neural network at step 816. At step 818, the processed data from the processing unit 120 is stored in the database 123. The database 123 may also store the raw complex image collected by the receiver 112 and the convoluted slices produced by the pre-processing unit 115. All or some of these data may be used to train the processing unit 120 for detecting specific concealed objects. The detection of concealed objects may trigger an alarm or notification to alert the concerned authorities 160 at step 820. The notification may be provided in audio/visual form. The process completes at step 822.

The term “convoluted” throughout this specification means “an outcome of the convolution operation”, or an “an outcome of a layer within a convolutional neural network”.

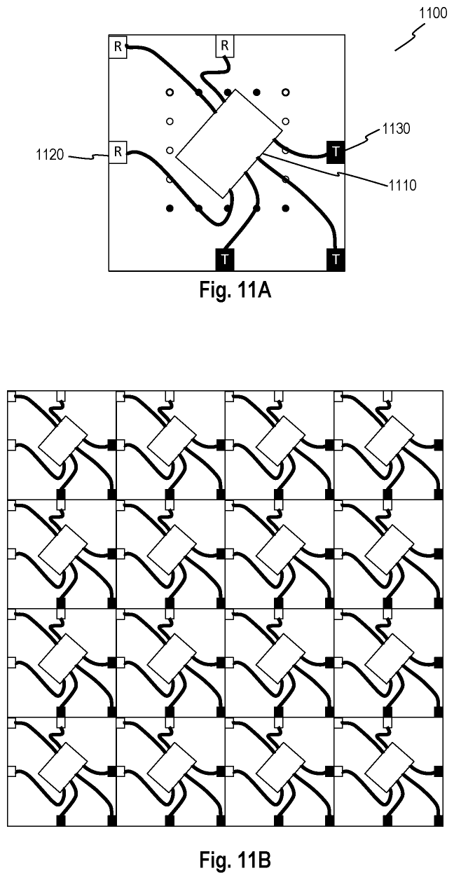

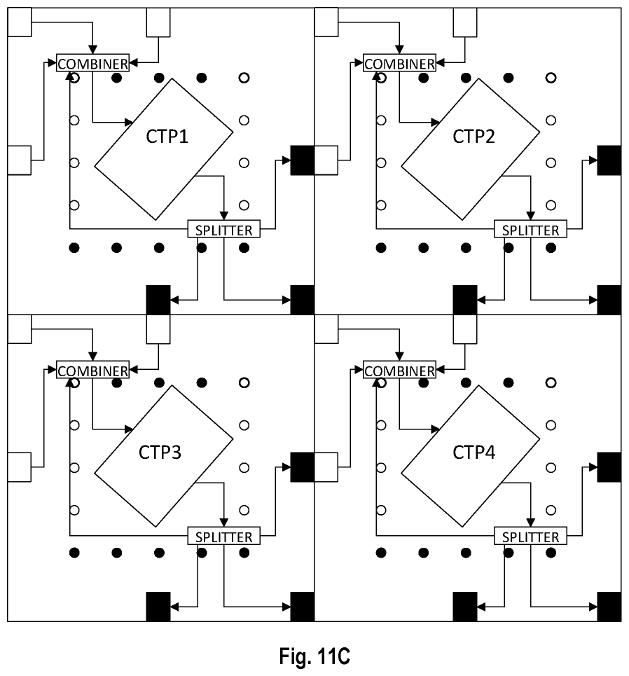

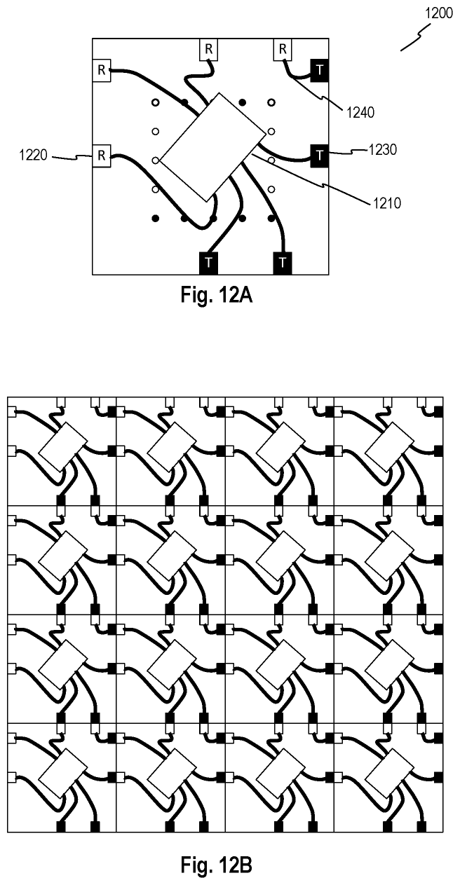

Reference is now made to FIG. 11A which illustrates an example of a transceiver frame board 1100 of the transmitting antenna 111. The transceiver frame board 1100 may be configured to communicate with the immediate in its quartet. Accordingly, the frame board includes a processing unit 1110, three receiver connectors 1120 and three transmitter connectors 1130. It is noted that each connector may provide at least a clock signal and a GPIO signal as required.

The three receiver connectors 1120 include a first receiver connector located on the upper border of the frame board, a second receiver connector located on the left border of the frame board, and a third receiver connector located at the upper left corner of the frame board.

The three transmitter connectors 1130 include a first transmitter connector located on the lower border of the frame board, a second transmitter connector located on the right border of the frame board, and a third transmitter connector located at the lower right corner of the frame board.

Accordingly, as illustrated in FIG. 11B the frame boards may be connected into larger arrays. The first transmitter connector of each frame board is configured to connect with the first receiver connector of an adjacent frame board situated along its lower border. The second transmitter connector of each frame board is configured to connect with the second receiver connector of an adjacent frame board situated along its right border. The third transmitter connector of each frame board is configured to connect with the third receiver connector of an adjacent frame board situated diagonally towards its lower left.

Referring to FIG. 11C a single quartet of frame boards is illustrated indicating how the signals from each receiving connector may pass via a combiner to a single input for the processor. Similarly, the output of the processor may pass to a splitter before being passed to the transmitter connectors.

It will be appreciated that in practice corner connections may be difficult to align and connect. Accordingly, a bridging connector may be used. An example of an alternative embodiment of a transceiver frame board 1200 including a bride connector is presented in FIG. 12A. The alternative frame board includes a processing unit 1210, four receiver connectors 1220 and four transmitter connectors 1230 and a bridge line 1240.

The four receiver connectors 1220 include a first receiver connector located on the upper border of the frame board, a second receiver connector located on the left border of the frame board, a third receiver connector located on the left border towards the upper left corner of the frame board, and a fourth receiver connector located on the upper border towards the upper right corner of the frame board.

The four transmitter connectors 1230 include a first transmitter connector located on the lower border of the frame board, a second transmitter connector located on the right border of the frame board, a third transmitter connector located on the lower border towards the lower right corner of the frame board and the fourth receiver connector located on the upper border towards the upper right corner of the frame board.

The bridging line 1240 provides a transmission line between the fourth receiver connector and the fourth transmitter connector such that a signal received at the fourth receiver connector is passed straight to the fourth transmitter connector bypassing the processor.

Accordingly, as illustrated in FIG. 12B, the alternative frame boards may be connected into larger arrays. The first transmitter connector of each frame board is configured to connect with the first receiver connector of an adjacent frame board situated along its lower border. The second transmitter connector of each frame board is configured to connect with the second receiver connector of an adjacent frame board situated along its right border.

It is a particular feature of the is embodiment that the third transmitter connector of each frame board is configured to connect with the fourth receiver connector of the adjacent frame board situated along its lower border. In this manner each frame board may communicate with its diagonal neighbors via the bridging line of the intermediate board.

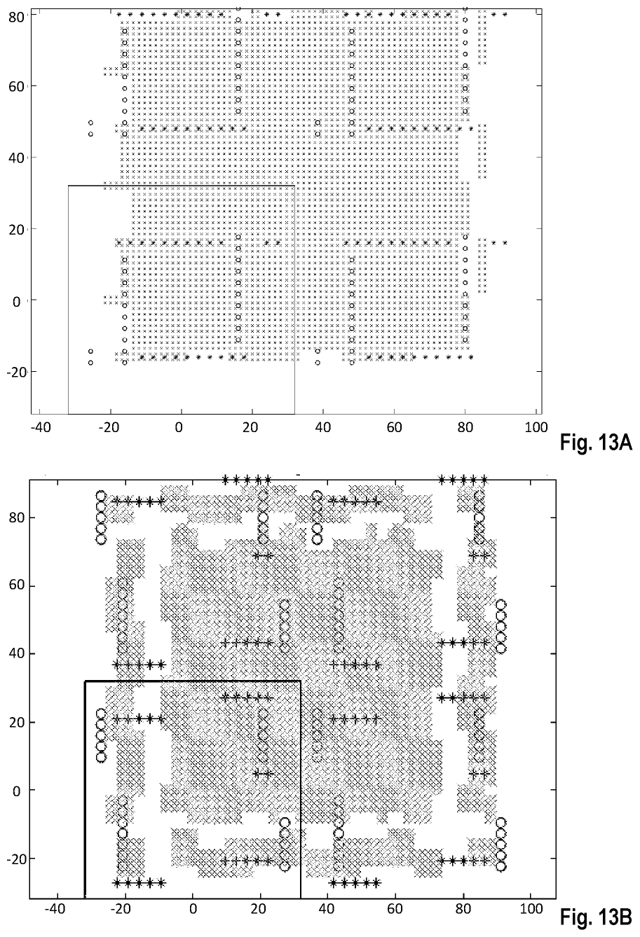

FIGS. 13A and 13B, show various possible antenna topologies may be used in the transceiver frames of the embodiments.

The systems and methods explained above may detect specific concealed objects in an efficient and accurate manner thereby reducing false alarms.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims. Additionally, the various embodiments set forth hereinabove are described in terms of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

1. A radar system for scanning a target subject and detecting concealed objects, the system comprising a radar-based sensor unit, a pre-processing unit and a processing unit, wherein:
the radar-based sensor unit comprises:
an array of transmitters configured to transmit a beam of electromagnetic radiations towards the target subject; and
an array of receivers configured to receive a beam of electromagnetic radiations reflected from the target subject, wherein the electromagnetic radiations received by the receiver comprise a raw complex image;
the pre-processing unit is configured to receive the raw complex image from the receivers and generate a plurality of convoluted slices; and
the processing unit is configured to receive the convoluted slices from the pre-processing unit and detect the concealed object within the target subject.

2-7. (canceled)

8. The radar system of claim 1 further comprising a database configured to store one or more of the raw complex images received by the receiver, the convoluted slices generated by the pre-processing unit and an identification of the detected concealed object.

9-10. (canceled)

11. The radar system of claim 1 further comprising a communicator configured to transmit a notification of the detected concealed object to one or more concerned authorities through a communication network.

12. The radar system of claim 8 further comprising an anomaly detector which is configured to detect deviation of the detected concealed object from a standard identification stored in the database.

13. (canceled)

14. The radar system of claim 1, wherein the radar-based sensor unit is selected from at least one of a group consisting of portable hand devices, full body scanners, walk-through scanners and combinations thereof.

15-18. (canceled)

19. The radar system of claim 1, wherein the radar-based sensor unit comprises one or more of the processing unit, a database, a communicator and an anomaly detector.

20. (canceled)

21. A method for scanning a target subject and detecting concealed objects, the method comprising:
transmitting, by an array of transmitters, a beam of electromagnetic radiations towards the target subject;
receiving, by an array of receivers, a beam of electromagnetic radiations reflected from the target subject, wherein the received electromagnetic radiations comprise a raw complex image;
receiving, by a pre-processing unit, the raw complex image from the receivers and generating a plurality of convoluted slices; and
processing, by a processing unit, the convoluted slices for detecting the concealed object within the target subject.

22. The method of claim 21, wherein the raw complex image comprises a 3D matrix of voxels.

23. The method of claim 22, wherein the convoluted slices are maximum intensity slices, wherein the maximum intensity slice is a matrix of the energy levels of the voxels with the highest intensity for each pair of orthogonal coordinates.

24. The method of claim 22, wherein the convoluted slices are range slices, wherein the range slice is a matrix of argument values of the voxels with the highest energy values for each pair of orthogonal coordinates.

25. The method of claim 22, wherein the convoluted slices are Laplacian slices, wherein the Laplacian slice is a matrix of phase values of a z-plane containing the voxel having the highest intensity.

26. The method of claim 22, wherein the convoluted slices are median value slices, wherein the median value slice is a matrix of average energy values for each voxel.

27. The method of claim 21, wherein the concealed objects are detected by the processing unit from the convoluted slices using a Convolutional neural network.

28. The method of claim 21 further comprising storing, in a database, one or more of the raw complex images received by the receiver, the convoluted slices generated by the pre-processing unit and an identification of the detected concealed object.

29. The method of claim 28 further comprising training the processing unit for detecting the concealed objects using the information stored in the database.

30. The method of claim 29, wherein the training of the processing unit for detecting the concealed objects is done using a Machine Learning (ML) algorithm.

31. The method of claim 21 further comprising transmitting, by a communicator, a notification of the detected concealed object to one or more concerned authorities through a communication network.

32. The method of claim 28 further comprising detecting, by an anomaly detector, deviation of the detected concealed object from a standard identification stored in the database.

33. The method of claim 32, wherein the detected deviation is indicative of detection of non-specific concealed objects.

34. The method of claim 21 further comprising detecting, by the processing unit, at least one of a position of the concealed object within the target subject, a size of the concealed object, and a shape of the concealed object.

35-81. (canceled)
